(19) United States
(12) Patent Application Publication
(10) Pub. No.: US 2026/0269413 A1
(43) Pub. Date: Sep. 10, 2026

(54) TRACTION BATTERY PACK CELL HOLDER WITH FLEXIBLE SLEEVES

(71) Applicant: Ford Global Technologies, LLC, Dearborn, MI (US)

(72) Inventors: Antony George Schepak, Howell, MI (US); Mohammadreza Eftekhari, Novi, MI (US); Deanna Marie Winton Hoffman, Ann Arbor, MI (US); Patrick Daniel Maguire, Ann Arbor, MI (US); Daniel Benjamin Kok, Ann Arbor, MI (US)

(21) Appl. No.: 19/304,654

(22) Filed: Aug. 20, 2025

Related U.S. Application Data
(60) Provisional application No. 63/766,671, filed on Mar. 4, 2025.

(51) Int. Cl. H01M 50/291; B60L 50/64; H01M 10/613; H01M 10/625; H01M 10/643; H01M 10/653; H01M 10/6567; H01M 50/213; H01M 50/249; H01M 50/293

(52) U.S. Cl. CPC H01M 50/291; H01M 10/613; H01M 10/625; H01M 10/643; H01M 10/653; H01M 10/6567; H01M 50/213; H01M 50/249; H01M 50/293; B60L 50/64; H01M 2220/20

(57) ABSTRACT

A traction battery pack assembly includes one or more battery cells, and a cell holder assembly having a frame and a plurality of sleeves. The cell holder assembly holds each battery cell within a cell receiving opening of the frame with at least one sleeve disposed between the frame and the battery cell.

### CROSS-REFERENCE TO RELATED APPLICATIONS

This application claims the benefit of U.S. Provisional Application No. 63/766,671, filed 4 Mar. 2025, the entirety of which is herein incorporated by reference.

### TECHNICAL FIELD

This disclosure relates generally to a cell holder of a traction battery pack and, more particularly, to a cell holder having a sleeve that flexes.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

In some aspects, the techniques described herein relate to a traction battery pack assembly, including: one or more battery cells; and a cell holder assembly having a frame and a plurality of sleeves, the cell holder assembly holding each battery cell within a cell receiving opening of the frame with at least one sleeve disposed between the frame and the battery cell.

In some aspects, the techniques described herein relate to a traction battery pack assembly, wherein the cell holder assembly is an extruded cell holder assembly.

In some aspects, the techniques described herein relate to a traction battery pack assembly, wherein the plurality of sleeves are corrugated sleeves.

In some aspects, the techniques described herein relate to a traction battery pack assembly, wherein the plurality of sleeves are disposed between the frame and the battery cell.

In some aspects, the techniques described herein relate to a traction battery pack assembly, wherein the plurality of sleeves are more flexible than the frame.

In some aspects, the techniques described herein relate to a traction battery pack assembly, wherein the frame and the plurality of sleeves are extruded.

In some aspects, the techniques described herein relate to a traction battery pack assembly, wherein the frame and the plurality of sleeves are coextruded.

In some aspects, the techniques described herein relate to a traction battery pack assembly, wherein the one or more battery cells are cylindrical battery cells.

In some aspects, the techniques described herein relate to a traction battery pack assembly, wherein the cell holder assembly is immersed in a liquid coolant.

In some aspects, the techniques described herein relate to a traction battery pack assembly, wherein the cell holder assembly is disposed within an enclosure assembly.

In some aspects, the techniques described herein relate to a traction battery pack assembly, wherein the frame directly contacts a liquid coolant within an interior of the enclosure assembly.

In some aspects, the techniques described herein relate to a traction battery pack assembly, wherein the cell receiving opening is lined with at least one sleeve.

In some aspects, the techniques described herein relate to a traction battery pack assembly, wherein the frame is secured directly to the enclosure assembly.

In some aspects, the techniques described herein relate to a traction battery pack assembly, wherein a first side of the cell holder assembly is attached directly to a cover of the enclosure assembly, and an opposite, second side of the cell holder assembly is attached directly to a tray of the enclosure assembly.

In some aspects, the techniques described herein relate to a traction battery pack assembly, wherein the frame, the enclosure assembly, and the plurality of sleeves are each polymer-based materials.

In some aspects, the techniques described herein relate to a traction battery pack assembly, including: a plurality of battery cells; and a cell holder assembly having a frame with a plurality of cell receiving openings and one or more sleeves disposed within each of the cell receiving openings, the cell receiving openings each configured to receive at least one of the battery cells with the one or more sleeves disposed between the at least one of the battery cells and the frame.

In some aspects, the techniques described herein relate to a traction battery pack assembly, wherein the one or more sleeves are cylindrical.

In some aspects, the techniques described herein relate to a traction battery pack assembly, wherein the one or more sleeves and the frame are coextruded.

In some aspects, the techniques described herein relate to a traction battery pack assembly, wherein the one or more sleeves each include a plurality of distinct sides.

In some aspects, the techniques described herein relate to a traction battery pack assembly, wherein the cell holder assembly is immersed in a liquid coolant.

### BRIEF DESCRIPTION OF THE DRAWINGS

FIG. 1 schematically illustrates an electrified vehicle.

FIG. 2 illustrates a plurality of cylindrical battery cells relative to the electrified vehicle of FIG. 1.

FIG. 3 illustrates a perspective view of selected portions of a traction battery pack from the electrified vehicle of FIG. 1.

FIG. 4 illustrates an expanded view of the portions shown in FIG. 3.

FIG. 5 illustrates a section view taken at line 5-5 in FIG. 3.

FIG. 6 illustrates a top view of a cell holder assembly from the traction battery pack of FIGS. 3-5 when the cell holder assembly is not holding batteries.

FIG. 7 illustrates a closeup view of an area of FIG. 6.

FIG. 8 illustrates the area of FIG. 7 when the cell holder assembly is holding battery cells.

FIG. 9 illustrates a closeup view of an area of a cell holder assembly according to another exemplary embodiment.

FIG. 10 illustrates a closeup view of an area of a cell holder assembly according to yet another exemplary embodiment.

### DETAILED DESCRIPTION

This disclosure relates generally to holding battery cells within a traction battery pack and, in particular, to holding the battery cells using a cell holder assembly having a frame with cell receiving openings that are lined with sleeves. As a battery cell is received within one of the cell receiving openings, the sleeve can flex.

When the battery cell is within the cell receiving opening, the sleeve can facilitate thermal contact between the battery cell and the frame of the cell holder assembly. Among other things, the sleeves can fill gaps between the frame and the battery cells to facilitate thermal transfer between the battery cell and the frame. The frame and the sleeves can be coextruded together such that the cell holder assembly is coextruded cell holder assembly. These and other benefits will be appreciated from the below.

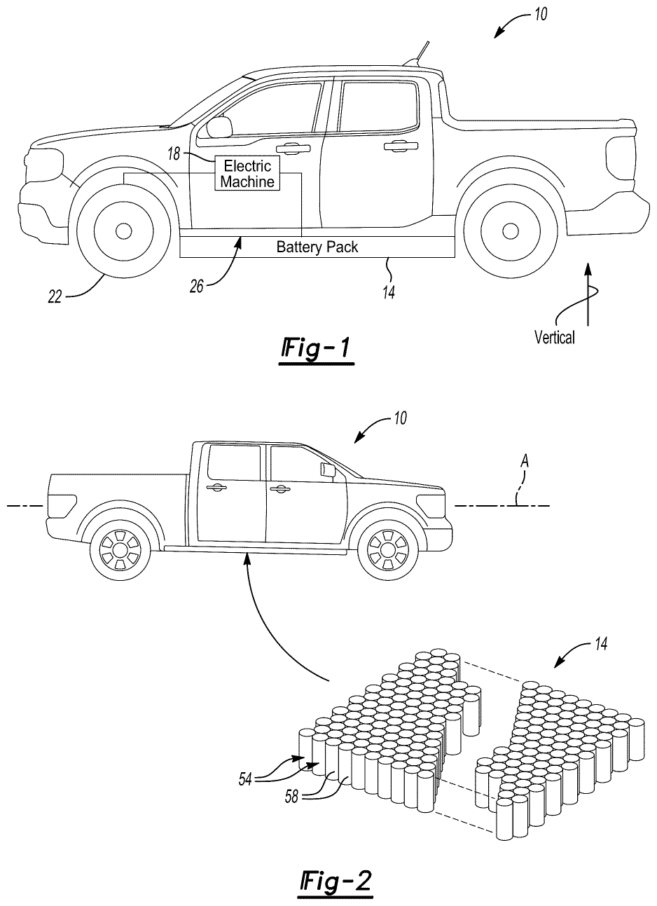

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The example electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference to FIG. 2, the battery pack 14 includes a plurality of individual battery cells 54. Each of the battery cells 54 has an outer case 58, which can be a metal or metal alloy. The outer cases 58 are cylindrical, or substantially cylindrical, in this example. The battery cells 54 may be referred to as cylindrical battery cells. The battery cells 54 include terminals configured to electrically couple to other battery cells 54 and/or busbars, as examples, adjacent a common side thereof, which in this example is a top side.

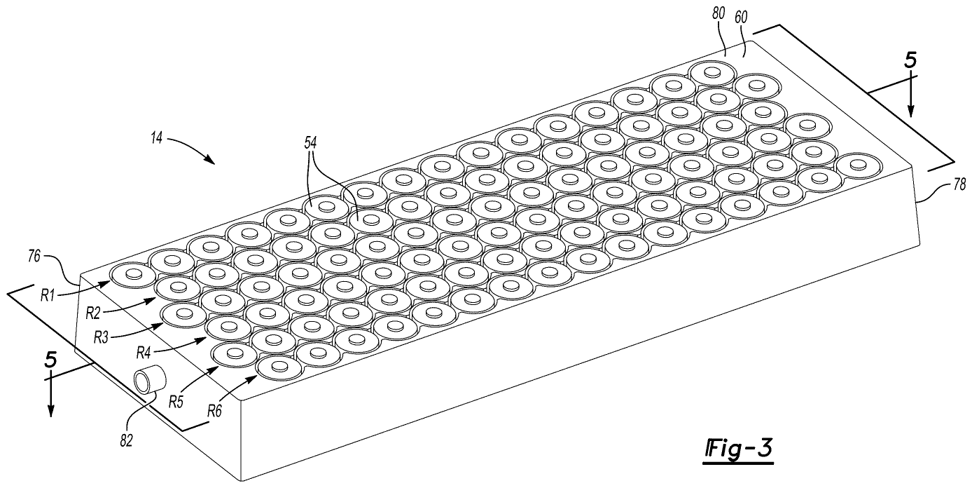

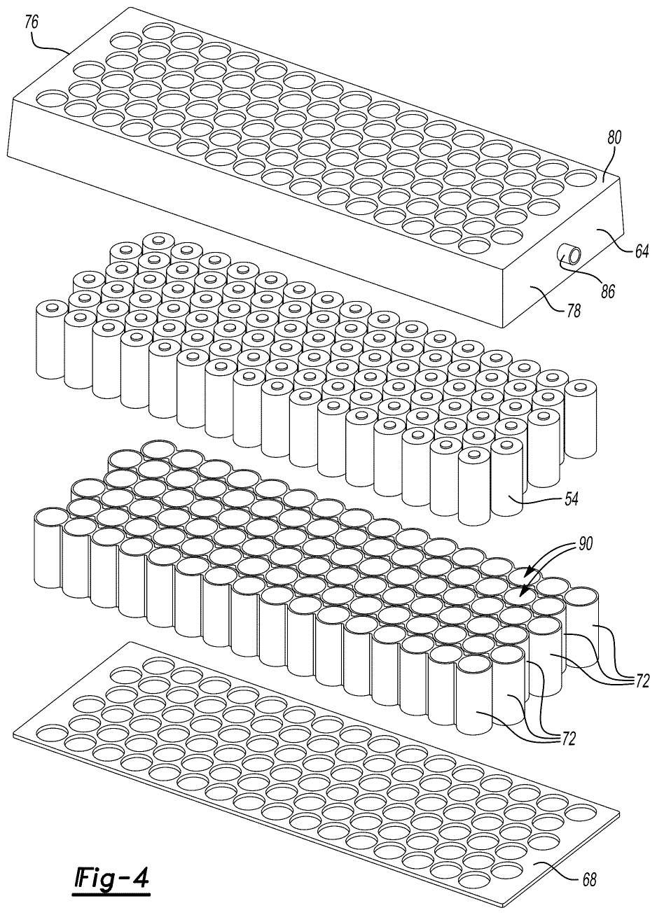

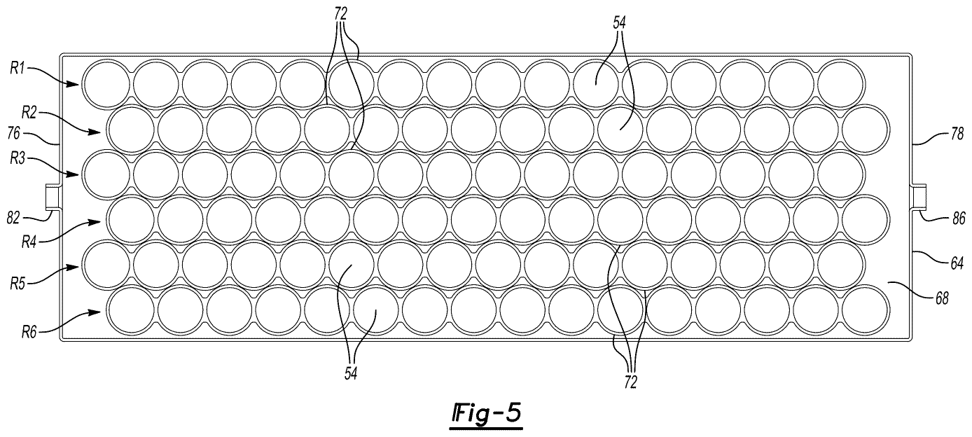

With reference now to FIGS. 3-5, the battery pack 14 includes an enclosure assembly 60 having an enclosure cover 64 and an enclosure tray 68 that meet to establish an interior area. The traction battery pack 14 further includes a plurality of cell holder assemblies 72 within the interior area. The cell holder assemblies 72 hold the battery cells 54 within the enclosure assembly 60.

In this example, the battery cells 54 are arranged in rows R1-R6. The rows R1-R6 each extend generally from a first end wall 76 of the enclosure cover 64 to a second end wall 78 of the enclosure cover 64. While there are six rows R1-R6 in this example, this disclosure extends to battery packs with different numbers of rows. Further, this disclosure is not limited to the particular number of battery cells in a particular row.

Rows R1-R6 are each generally parallel to one another and, optionally, parallel to a longitudinal axis of the vehicle 10. Adjacent rows R1-R6 are staggered relative to one another to enable closer packaging of the battery cells 54, which results in the battery cells 54 having a generally honeycomb arrangement.

In this example the battery cells 54 are arranged such that electrical connections between adjacent battery cells 54 are made adjacent a top wall 80 of the enclosure cover 64, and a venting arrangement for the battery cells 54 is arranged adjacent the enclosure tray 68. The venting arrangement can include openings that open in response to a venting event to permit vent byproducts to move through the enclosure tray 68.

The enclosure assembly 60 includes an inlet 82 through the first end wall 76 and an outlet 86 through the second end wall 78. A liquid coolant, such as water, can move through the inlet 82 into the interior area established between the enclosure cover 64 and enclosure tray 68. The thermal management fluid can exit from the interior area through the outlet 86. The thermal management fluid is circulated through the interior area to manage thermal energy levels of the battery cells 54 and other components of the battery pack 14.

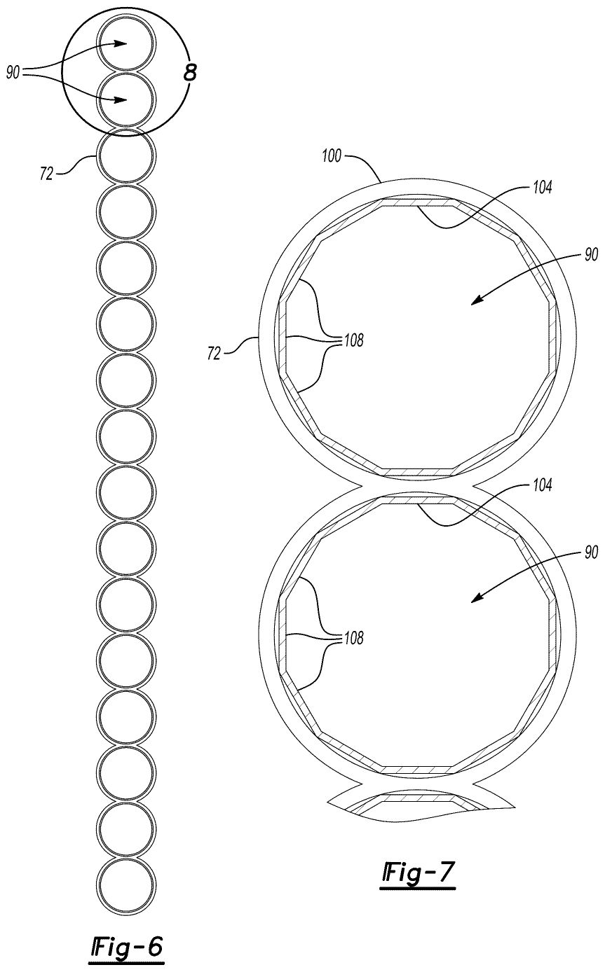

With reference now to FIGS. 6-8 and continuing reference to FIGS. 3-5, the cell holder assemblies 72 are disposed within the interior area. Each of the cell holder assemblies 72 includes a plurality of cell receiving openings 90. In this example, each cell receiving opening 90 receives one of the battery cells 54. In another example, each cell receiving opening 90 could receive more than one of the battery cells 54.

Thermal energy can transfer between the battery cells 54 through the cell holder assemblies 72 to the liquid coolant within the interior area. In some examples, thermal energy can transfer from the battery cells 54 through the cell holder assemblies 72 to the liquid coolant. The liquid coolant is then communicated through the outlet 86 away from the battery cells 54 to cool the battery cells 54.

Upper surfaces on first sides of the cell holder assemblies 72 are attached directly to the top wall 80 of the enclosure cover 64. Opposite second sides or bottom sides of the cell holder assemblies 72 are attached directly to the enclosure tray 68. To contain fluid within the interior area between the enclosure cover 64 and the enclosure tray 68, the connections between the cell holder assemblies 72, the enclosure cover 64, and the enclosure tray 68 can be fluid tight connections.

In this example, the enclosure cover 64, the enclosure tray 68, and the cell holder assemblies 72 can be polymer-based materials, and the cell holder assemblies 72 can be ultrasonically welded to the enclosure cover 64 and the enclosure tray 68. In other examples, the cell holder assemblies 72 are attached to the enclosure cover 64 and the enclosure tray 68 using another polymer welding technique, e.g., laser welding, hot plate welding, vibration welding, etc. The enclosure cover 64 and the enclosure tray 68 can be injection molded.

The cell holder assemblies 72 include a frame 100 and sleeves 104. The frame 100 provides the cell receiving openings 90. The example sleeves 104 are annular sleeves each extending circumferentially continuously about a periphery of one of the cell receiving openings 90. The sleeves 104 are disposed between the frame 100 and the battery cells 54 when the battery cells 54 is held by the cell holder assemblies 72.

The frame 100 and the sleeves 104 are different materials in this example-both materials are polymer-based. The polymer material of the sleeve 104 is more flexible than the polymer material of the frame 100. Put another way, the frame 100 is more rigid than the sleeves 104. In some examples, the frames 100 are a synthetic polymer, such as polyamide 66, and the sleeves 104 are a thermoplastic vulcanized rubber. The sleeves 104 could be a foam polymer in another example, which could flex by compressing. For purposes of this disclosure, the flexing of the sleeves 104 extends to cover sleeves that displace, compress, bend or some combination of these.

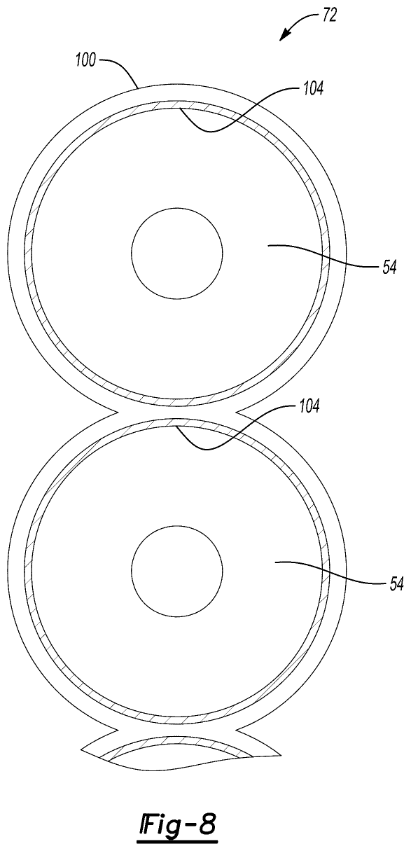

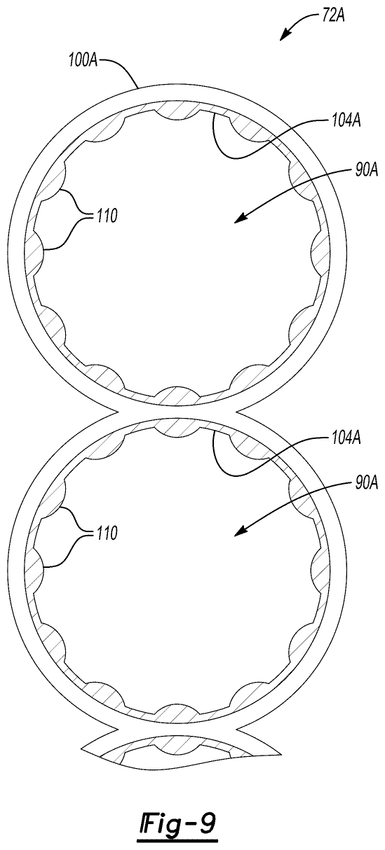

The sleeves 104, in this example, are configured to flex from the position shown in FIG. 7 to the position shown in FIG. 8 as a respective one of the battery cells 54 is received within the corresponding cell receiving opening 90.

The example sleeves 104, to facilitate flexing, can be considered corrugated sleeves as the sleeves 104 comprised of a plurality of distinct sides 108 or facets. Here, for drawing clarity, the sleeves 104 are shown as including twelve sides 108. The sleeves 104 may include many more sides. In some examples, the sleeves 104 could include twenty-four sides. The sides 108 or facets can be considered axially extending corrugations. In another example, the corrugations could be annular or circumferentially extending corrugations.

The sides 108 of the sleeves 104 flex in response to the battery cell 54 moving into the corresponding cell receiving opening 90. In another example, the sleeves 104 could be circular and could lack distinct sides. Such the sleeves could flex by being displaced around the frame 100 and the battery cell 54 when the battery cell 54 is inserted into the associated cell receiving opening 90. The battery cell 54 is held by such sleeves with an interference or press fit

In this example, one of the cell holder assemblies 72 holds all of the cells 54 within a given one of the rows R1-R6. The frames 100 of the example cell holder assemblies 72 each include sixteen individual cell receiving openings 90. In other examples, the cell holder assemblies 72 could other numbers of cell receiving openings 90. Some cell holder assemblies 72 could include a single cell receiving opening. Each of these cell receiving openings 90 in the cell holder assemblies 72 is lined by one of the sleeves 104. In other examples, each of the openings 90 could be lined by more than one of the sleeves 104.

The frame 100 is in direct contact with the liquid coolant within the interior of the enclosure assembly 60. Thermal energy can transfer between the battery cells 54, through sleeves 104, through the frame 100, and into the liquid coolant within the interior area. The sleeves 104 can fill airgaps between the frame 100 and the battery cells 54 to facilitate thermal conductivity. The sleeves 104 can also help to retain the battery cells 54.

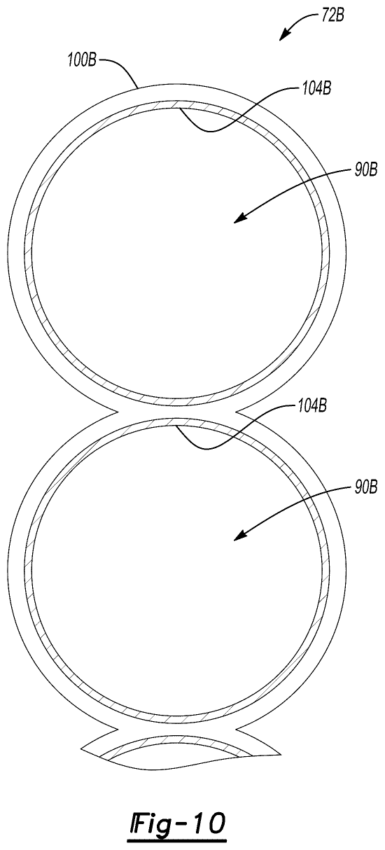

As shown in FIG. 9, a cell holder assembly 72A according to another exemplary embodiment includes a sleeve 104A having flutes 110 rather than distinct sides. The flutes are configured to displace in response to insertion of a battery cell into the cell receiving opening 90A. The sleeve 104A is held within a frame 100A

As shown in FIG. 10, a cell holder assembly 72B according to yet another exemplary embodiment included a sleeve 104B that lacks flutes or distinct sides. A battery cell can hold a battery cell within a cell receiving opening 90B using an interference fit. The sleeve 104B is held within a frame 100B.

The example cell holder assemblies 72, 72A, 72B are extruded cell holder assemblies. In this example, the sleeves for a given one of the cell holder assemblies 72, 72A, 72B are extruded together with the frame. The sleeves and the frame are thus coextruded.

Specifying that cell holder assemblies 72, 72A, 72B are extruded cell holder assemblies, and that the sleeves and the frames of the cell holder assemblies 72, 72A, 72B are coextruded is a structural feature. In the exemplary embodiment, the sleeve and the frame for each of the example cell holder assemblies 72, 72A, 72B are formed together in a single coextrusion operation. This coextrusion results in an integral, unitary construction in which the sleeve and the frame are bonded along their interfacing areas without any intervening adhesive or mechanical fastening. The coextrusion process imparts structural features that are distinguishable from separately formed components that are later joined. The coextruded cell holder assemblies 72. 72A, 72B can, for example, exhibit a substantially continuous molecular interface or interdiffusion zone between the materials of the respective sleeves and frames. This interface can provide enhanced structural integrity and enhanced sealing performance.

Accordingly, the coextruded nature of the example cell holder assemblies 72, 72A, 72B constitutes a structural limitation that distinguishes the cell holder assemblies 72, 72A, 72B from products that include separately formed components joined by adhesive bonding, mechanical attachment, or other assembly methods. The skilled person would be able to structurally distinguish a sleeve coextruded with a frame from a sleeve that is not coextruded with a frame. Thus, coextrusion is a structurally distinguishing feature. In another example, the sleeves 104 could be extruded or otherwise produced separate from the frame 100 and then inserted into the frame 100 to line the cell receiving openings 90.

One of ordinary skill in this art would understand that the above-described embodiments are exemplary and non-limiting. That is, modifications of this disclosure would come within the scope of the claims. Accordingly, the following claims should be studied to determine their true scope and content.

1. A traction battery pack assembly, comprising:
one or more battery cells; and
a cell holder assembly having a frame and a plurality of sleeves, the cell holder assembly holding each battery cell within a cell receiving opening of the frame with at least one sleeve disposed between the frame and the battery cell.

2. The traction battery pack assembly of claim 1, wherein the cell holder assembly is an extruded cell holder assembly.

3. The traction battery pack assembly of claim 1, wherein the plurality of sleeves are corrugated sleeves.

4. The traction battery pack assembly of claim 1, wherein the plurality of sleeves are disposed between the frame and the battery cell.

5. The traction battery pack assembly of claim 1, wherein the plurality of sleeves are more flexible than the frame.

6. The traction battery pack assembly of claim 5, wherein the frame and the plurality of sleeves are extruded.

7. The traction battery pack assembly of claim 6, wherein the frame and the plurality of sleeves are coextruded.

8. The traction battery pack assembly of claim 1, wherein the one or more battery cells are cylindrical battery cells.

9. The traction battery pack assembly of claim 1, wherein the cell holder assembly is immersed in a liquid coolant.

10. The traction battery pack assembly of claim 1, wherein the cell holder assembly is disposed within an enclosure assembly.

11. The traction battery pack assembly of claim 10, wherein the frame directly contacts a liquid coolant within an interior of the enclosure assembly.

12. The traction battery pack assembly of claim 10, wherein the cell receiving opening is lined with the at least one sleeve.

13. The traction battery pack assembly of claim 10, wherein the frame is secured directly to the enclosure assembly.

14. The traction battery pack assembly of claim 13, wherein a first side of the cell holder assembly is attached directly to a cover of the enclosure assembly, and an opposite, second side of the cell holder assembly is attached directly to a tray of the enclosure assembly.

15. The traction battery pack assembly of claim 13, wherein the frame, the enclosure assembly, and the plurality of sleeves are each polymer-based materials.

16. A traction battery pack assembly, comprising:
a plurality of battery cells; and
a cell holder assembly having a frame with a plurality of cell receiving openings and one or more sleeves disposed within each of the cell receiving openings, the cell receiving openings each configured to receive at least one of the battery cells with the one or more sleeves disposed between the at least one of the battery cells and the frame.

17. The traction battery pack assembly of claim 16, wherein the one or more sleeves are cylindrical.

18. The traction battery pack assembly of claim 16, wherein the one or more sleeves and the frame are coextruded.

19. The traction battery pack assembly of claim 16, wherein the one or more sleeves each include a plurality of distinct sides.

20. The traction battery pack assembly of claim 16, wherein the cell holder assembly is immersed in a liquid coolant.
